(19) United States
(12) Patent Application Publication
(10) Pub. No.: US 2006/0209873 A1
(43) Pub. Date: Sep. 21, 2006

(54) Characterisation of service quality for an information transmission in a communication network

(76) Inventors: Andreas Knabchen, Muenchen (DE); Rainer Liebhart, Schrobenhausen (DE); Heribert Muller, Eggenburg (AU)

Correspondence Address: Siemens Corporation;Intellectual Property Department, 170 Wood Avenue South, Iselin, NJ, 08830, US

(21) Appl. No.: 10/486,272

(22) PCT Filed: Aug. 6, 2002
(86) PCT No.: PCT/EP02/08774

§ 371 Date: Sep. 16, 2004

(30) Foreign Application Priority Data
Aug. 8, 2001 (EP) 01119178.0

(51) Int. Cl. H04B 7/212

(52) U.S. Cl. 370/443; 370/465; 379/229

(57) ABSTRACT

The invention relates to a communication network, comprising a call control level (CCL), a resource control level (RCL) and at least one endpoint (A), associated with an information transfer, whereby a request (RQ) for a quality of service (QoS), determined for an information transfer is only exhaustively verified at the call control level (CCL). Subsequently, an encoded token (T) is formed and transmitted to the resource control level (RCL) by means of the endpoint (A). The above verifies a QoS request (RQ) coming from the endpoint (A), merely by means of the decoded token (T). Where successful the communication network is configured such that information with the QoS verified as above is transmitted. The invention permits an efficient secure and accurate provision of QoS in integrated speech and data networks. In particular extensive modifications to existing routers in the resource control level (RCL) are avoided. Furthermore, on regular repeated transmission of the token (T) a consistent provision of the available QoS and a secure and precise billing for the information transfer are supported.

The invention relates to methods and devices, in particular computer program products, for saving data to characterize the quality of service for an information transmission in a communication network.

In the past, two main types of communication network have developed for the transmission of information: packet-oriented data networks and line-oriented voice networks. These differ, among other respects, in their different grade of service requirements.

Grade of service—also called QoS (Quality of Service)—has different definitions depending on the context, and in what follows is measured using different metrics. Familiar examples of metrics for the measurement of quality of service are the maximum number of transmissible items of data (the bandwidth), the number of items of data not transmitted (loss rate), the—possibly standardized—deviation from the otherwise general interval between each two data transmissions (delay jitter, interarrival jitter), or the number of items of data counted from the first ones for which transmission just could not be permitted (the blocking rate).

Line-oriented voice networks are designed for the transmission of (speech) data which flows continuously, referred to in the technical world as a ‘call’ or a ‘session’. Here, the data is commonly transmitted with a high quality of service and security.

For example, for speech a minimum delay—e.g. <200 ms—with no variations in the delay time (delay jitter) is important, because when it is reproduced at the receiving device speech calls for a continuous flow of data. For this reason, any loss of data cannot be compensated by re-transmission of the data which was not transmitted, and generally leads to an audibly detectable breakup at the receiving device. In technical circles, the transmission of speech is generally also described as a ‘real-time (transmission) service’. The quality of service is achieved by appropriate dimensioning and planning of the voice network, with the transmission capacity itself being fundamentally subject to no fluctuations, as a result of the line orientation. Security is effected, for example, by appropriate spatial and organizational segregation of the voice network from unauthorized third parties. Consequently, in the past the responsibility for voice networks often lay, for example, in government hands, which made it possible for example to largely exclude eavesdropping by third parties.

Packet-oriented networks are designed for the transmission of packet streams, referred to in specialist circles as ‘data packet streams’. For these, it is not normally necessary to guarantee a high quality of service. When there is no guaranteed quality of service, the data packet streams are transmitted, for example, with delays of variable time length, because the individual data packets in the data packet stream are generally transmitted in the sequence in which they arrive in the network, i.e. the time delays are larger the more packets are being transmitted by the data network. In specialist circles, the transmission of data is therefore also described as a ‘non real-time service’. Security plays a less important role. In small networks, such as for example local area networks (LANs) or internal company networks (corporate networks—also referred to as virtual private networks (VPNs)) it is generally effected by spatial segregation or the network, because the only subscribers in such networks are those who are authorized from the outset (so-called ‘friendly users’).

The currently best-known data network is the Internet. The Internet is conceived as an open (wide-area) data network, with open interfaces for connecting in the (generally local or regional) data networks of different vendors. The main focus of attention until now has therefore been on the provision of a vendor-independent transport platform. Adequate mechanisms for guaranteeing the quality of service and security play a subordinate role. For this reason, any increased security is currently realized by means of local filtering facilities—also referred to as ‘firewalls’—located at the interfaces to the Internet. There are, however, hardly any facilities for quality of service and security internally within the network.

As the convergence of line-oriented voice networks and packet-oriented data networks has progressed, speech transmission services and also more broadband services such as the transmission of moving picture data are also being implemented in packet-oriented networks, i.e. the transmission of real-time services, which until now has commonly been on a line-oriented basis, is being effected in a convergent voice-data network on a packet-oriented basis, i.e. in packet streams. These are also referred to as ‘real-time packet streams’. This is the source of the problem, in that a packet-oriented implementation of a real-time service demands a high quality of service, so that it is qualitatively comparable with a line-oriented transmission, whereas up-to-date data networks, and in particular the Internet, do not provide any adequate mechanisms for guaranteeing a high quality of service.

In what follows, the focus is on the transmission of multi-media data (e.g. audio or video) over the Internet. However, this does not represent any essential restriction, because the quality of service requirements are not formulated specially for the Internet, but apply generally for all types of data networks. They are independent of the specific form in which a data network is realized. Consequently, the packets can be in the form of Internet, X.25 or frame relay packets, or can even be constructed as ATM cells. From time to time they are also referred to as ‘messages’, mainly when a message is transmitted in a packet. Here, data packet streams and real-time packet streams are exemplary embodiments of traffic steams transmitted through communication networks. Traffic streams are also called ‘connections’, even including those in packet-oriented networks which use a connectionless transmission technology. For example, with TCP/IP data transmission is effected by means of so-called flows, by which the sender and receiver (e.g. a Web server and a browser) are linked together at a logically abstract level in spite of the connectionless character of IP, i.e. from a logically abstract point of view flows also represent connections.

For the transmission of speech and image data over a packet-oriented IP network (for example the Internet)—also referred to as ‘VoIP’—several architectures have been specified by the international standardization committees—IETF (Internet Engineering Task Force) and ITU (International Telecommunications Union). A common feature of all of them is that the call control level and the resource control level are functionally separated from each other.

The call control level comprises an (optional) call controller, to which the functions assigned include the following:
Address Translation: conversion of E.164 telephone numbers and other alias addresses (e.g. computer names) to transport addresses (e.g. Internet addresses)
Admission Control (optional): basic permissibility checking as to whether and to what extent (e.g. VoIP capability) devices may use the communication network.
Bandwidth Control (optional): management of transmission capacities.
Zone Management: registration of (e.g. VoIP-capable) devices and provision of the above functions for all the devices registered with the Call Controller.

Optionally, the following functions can be assigned to a Call Controller on a case-by-case basis:
Call Control Signalling: all signalling messages are communicated by at least one Call Controller, i.e. all devices send and receive signalling messages only via the Call Controller. A direct exchange of signalling messages between the devices is forbidden.
Call Authorization: checks on permissibility for incoming and outgoing calls.
Bandwidth Management: control of the number of devices permitted to use the communication network simultaneously.
Call Management: management of a list of existing calls, for example in order to enable the generation of a busy tone if this cannot be generated by the device itself.
Alias Address Modification: return of a modified alias address, for example with an H.225.0 (complete reference op.cit.) ACF (Admission Confirm) message. This address must use the endpoint for connection establishment.
Dialed Digit Translation: conversion of the dialed digits into an E.164 telephone number or a number from a private numbering schema.

Examples of Call Controllers are represented by the ‘Gatekeeper’ proposed by the ITU in the H.323 Standard family, or the ‘SIP Proxy’ proposed by the IETF. If a larger network is subdivided into several domains—also called ‘zones’—it is possible to provide a separate Call Controller in each domain. A domain can also be operated without a Call Controller. If a number of Call Controllers are provided in one domain, then only one of them should be activated.

From the logical point of view, a Call Controller should be regarded as separate from the devices. Physically, however, it does not need to be implemented in a separate Call Controller device, but can also be incorporated into any endpoint of a connection (for example, structured as an H.323 endpoint: terminal device, gateway, multipoint control unit, etc.) or even a device designed for processing data under program control (for example: a computer, PC, etc.). Even a physically distributed implementation is possible.

The central element comprising the Resource Control level is a Resource Controller, to which the following functions are assigned:
Capacity Control: management of the traffic volume fed to the communication network by packet streams, e.g. by checking on the transmission capacity for individual packet streams.
Policy Activation (optional): if applicable, reserving resources in a communication network for the transmission of a prioritized packet stream.
Priority Management (optional): setting priority flags in the packets in accordance with the priorities of their packet streams and, if the packet streams already have priorities flagged, checking and if necessary correcting these.

The Resource Controller is also referred to as a ‘Policy Decision Point (PDP)’. It is often implemented within so-called ‘Edge Routers’—also called ‘Edge Devices’, ‘Access Nodes’ or, when assigned to an Internet Service Provider (ISP), ‘Provider Edge Routers (PERs)’. Alternatively, a PER can also function purely as a proxy, which forwards the data relevant to the Resource Controller to a separate server on which the Resource Controller is implemented.

The principle of how the Call Controller and the Resource Controller work together in accordance with the protocols of the IETF and the ITU (see H.323 Draft v4 (07/2000), Appendix II) will be explained by the example of a call setup between two VoIP devices in the form of subscriber terminal devices.

During, or to some extent even before, the time of the actual call setup, the steps of authentication, authorization and (start of) accounting are executed when a terminal device dials into the IP network (e.g. via an Internet service provider). This so-called ‘AAA’ functionality is commonly implemented by means of an access to a subscriber database, in which are stored the details of all the users with their identifiers, passwords, rights etc. This access is slow and comparatively complex. In today's ‘best effort’ IP networks, this AAA procedure normally takes place once, while the subscriber is dialing in. A further authentication is carried out when a Call Controller is used, when a terminal device registers itself with the Call Controller (e.g. a SIP proxy or an H.323 gatekeeper) in accordance with the RAS (registration, admission, status) protocol. This RAS protocol is specified in the ITU Standard H.225.0 (complete reference at specified location).

The actual call setup normally begins with a first step in which the subscribers' terminal devices exchange their capabilities (e.g. list of codecs supported), in order to determine the resources required (e.g. bandwidth) and the required QoS (e.g. delay, jitter). In the case of voice telephony, for example, the terminal devices are in the form of IP telephones, while for online video one of the terminal devices would be a content or application server, e.g. in the ISP's (Internet service provider's) network.

The signalling messages are exchanged either directly between the terminal devices or through the mediation of at least one Call Controller. In doing so, the variant used is specified individually for each call, for each terminal device and for each transmission direction. The first variant is referred to in H.323 Draft v4 (07/2000) as ‘Direct Endpoint Call Signalling’ and the second as ‘Gatekeeper Routed Call Signalling’. In the case of direct endpoint call signalling, copies of selected signalling messages can be transmitted to a Call Controller if necessary. This means that a Call Controller frequently has a knowledge of the resource and QoS requests agreed between the terminal devices. However, it does not itself actively influence or verify these requests.

In a second, optional, step the resource and QoS requests agreed in this way can be transmitted directly by the subscribers' terminal devices to their assigned Resource Controllers. After checking the resource and QoS requests, the Resource Controller sends a confirmation (or rejection) back to the terminal device.

In a third step, which is also optional, a policy is activated in the Edge Router, and if appropriate in other routers in the network, and is used by these routers to check and ensure that the traffic due to the terminal device lies within the limits which were specified in the request. An example of a reservation mechanism of this type is RSVP (Resource reSerVation Protocol).

In order to carry out these three steps, a plurality of messages are sent, which serve solely to reach agreement between the participating components, but not for the transmission of the “actual data” between the terminal devices. The data transmitted by these messages is commonly referred to as ‘signalling information’, ‘signalling data’ or simply ‘signalling’. This term should be interpreted in a broad sense. Thus it covers, for example, not only the signalling messages but also the messages in accordance with the RAS protocol, the messages in accordance with the ITU Standard H.245 for controlling user channels for established calls, and all other messages with a similar structure. The signalling protocol for call setup and call release according to the ITU is, for example, specified in the H.225.0 Standard, “Media Stream Packetization and Synchronization on Non-Guaranteed QoS LANs”, 2000, and that in accordance with the IETF is specified in RFC 2453bis, “SIP: Session Initiation Protocol”, draft-ietf-sip-rfc2453bis-02.txt, 09/2000. To distinguish it from the signalling, the “actual data” is also referred to as ‘user data’, ‘media information’, ‘media data’ or simply ‘media’.

In this connection, the term ‘out-of’ band’ means the transmission of data over a path/medium which differs from the paths provided in the communication network for the transmission of signalling and user data. In particular, it covers a local configuration of devices, set up for example by means of a local control device. In contrast, in the case of ‘in-band’ the data is transmitted on the same path/medium as the signalling and user data under consideration, although logically separated if appropriate.

From what has already been explained, it will be clear that an implementation of VoIP will only gain broad acceptance from subscribers if the associated signalling data and the media data in the form of speech is transmitted in the integrated voice-data network with the same quality of service as in the voice network. In doing this, a subscriber may of course agree in advance with an operator on a certain quality of service. However, in an integrated voice-data network, basically all the traffic streams are affected by fluctuations in the network load, so that if there is a high network load the agreed quality of service may not be achieved. In this context, it could be helpful to have the recording of data in accordance with the invention, and ideally on a continuous basis, characterizing the actual quality of service for each VoIP transmission so that, in the event of a dispute, provable data is available for judging the actual quality of service for disputed VoIP transmissions.

However, adequate technical provision cannot be made for such comprehensive and extensive recording of quality data, either with the means suggested in the standards and drafts of the IETF and/or ITU, or with familiar or published implementations and solutions.

One familiar approach is case-by-case recording with the help of measuring devices. Measuring devices in a network which monitor data transmissions, and those active systems which inject data directly into the network in order to make measurements, are generally known as sniffers or probing systems. For VoIP there are also measuring devices which function as terminal devices, initiate data transmissions and measure the transmission quality for a data transmission. Of course, these can only be used to make random samples, apart from which this method is of no help in the case of complaints from customers about their terminal device, their special network access and, in particular, the quality of service which they subjectively experience. In this case, a service technician must, for example, substitute the subscriber's terminal device on-site with a measuring device, so that quality data can be collected in response to the customer's complaint. With this method it is not possible to draw conclusions about quality deficiencies in the past, due for example to an excessive network load (also called ‘network queues’). Nor can it be used to prove that the actual quality of service corresponds or corresponded at all times to a promised quality of service.

Another familiar method is to collect quality data at intermediate (network-internal) points for a data transmission, e.g. at the interfaces (also called ‘gateways’) between networks (e.g. an interface between a line-oriented voice network and a packet-oriented integrated voice-data network) or at concentration points (also called ‘multiplexers’), at which numerous data transmissions are combined together by static or statistical multiplexing to form a higher bit rate data stream, so that they can be transmitted on a common channel. In RFC2705 from the IETF (Internet Engineering Task Force), Arango et al., “Media Gateway Control Protocol (MGCP)”, 10/1999, section 2.3.5, a suggestion is made for this, that an intermediate node for a data transmission should communicate to an assigned Call Agent certain statistical data for each data stream which it transmits, after the data transmission is completed. Here, the main function ascribed to the data in accordance with RFC1889, Schulzrinne et al., “RTP: A Transport Protocol for Real-Time Applications”, 01/1996, Chapter 6, “RTP Control Protocol—RTCP”, is support for flow and overload checking. According to RFC1889, section 6.3.4, the use of this data is directed selectively at the following effects:
A transmitter should be able to modify its transmission behavior during the transmission of data, depending on the statistical data it receives (flow and overload checking).
A receiver should be able to deduce whether a problem originates from a local, regional or global cause (fault localization).
A network monitor should be able to assess the network's data transmission capacity as a function of the statistical data (network performance). Here, the focus is on the network as a whole, but not on the individual data transmissions.

In neither RFC2705 nor RFC1889 is there any note about the use, specifically the storage, of this data for identifying the quality of service for a data transmission. In addition, this method is not scalable, because the cost in the intermediate nodes, which may for example take the form of gateways or multiplexers, rises linearly with the number of data streams transmitted. Because it is used in intermediate nodes, it is primarily intended for network-internal performance control of the network as a whole, by the flow and overload control of individual data streams, but not for characterizing the quality of service for individual data transmissions. In addition, with separate management of the data streams in a bidirectional data transmission, it is mainly only possible to make a unidirectional measurement. A subsequent processing step is then required for a bidirectional measurement result.

One object of the invention is to indicate a way which enables data for characterizing the actual quality of service for each data transmission in a communication network to be efficiently and continuously recorded.

This object is achieved by the features of claim 1. Further advantageous embodiments of the invention derive from the subclaims and other related claims.

Linked with the solution in accordance with claim 1 are a host of new, unexpected and advantageous technical effects:
The recording of data by the endpoint itself makes the solution scalable, For each endpoint it is only necessary to record data about the data communications assigned to the endpoint concerned. Furthermore—unlike in an intermediate node—a terminal device normally brings together only a limited, generally constant, number of endpoints (in the case of an H.323 terminal device, for example, one each for the forward and return directions for audio and video, one for H.245 signalling and one for H.225.0 signalling to the assigned gatekeeper). Any increase in the number of data communications in a network is normally due to an increase in the number of terminal devices connected to the network, but not to a (significant) increase in the endpoints per terminal device, so that the load on each terminal device due to the recording and communication of data in accordance with the invention remains largely uniform, i.e. constant.
Even in the case of separate management of the data streams for a bidirectional data communication over different paths in a network, it is basically possible to make a bidirectional measurement because the two data streams usually come together in the terminal device, so that there is no need for a retrospective correlation of the unidirectional measurements for each of the two communication directions to give a bidirectional measurement.
By recording the data in the endpoint for a data communication, the actual quality of service experienced can be continually measured and, by saving the data, can also be proven at any time. A proof of the actual quality of service is essential for the acceptance of the concepts proposed by the IETF and the ITU, because it can be used to provide a transparent indication to subscribers that a guaranteed quality of service was not only promised to them but was also actually provided.
The invention is generic, and conceptually interoperable, because it is independent of any specific solution. This makes the invention of itself a comprehensive solution for communication networks. In particular, it can be used both with H.323 networks and also with SIP networks. This is important, and hence particularly advantageous, because as has been shown in the past the market shows little acceptance of vendor-specific solutions.

One object, for which the instance is located in the Call Control Level of a communication network comprising a Call Control Level and a Resource Control Level, and specifically is assigned to a Call Controller provided in the Call Control Level, is associated with the advantageous effect that there is no need for separate addressing of the instance at the endpoints, because instead the address of the Call Controller, which is already present, can be used. As a consequence, there is also no need for the address of the instance to be configured in the terminal devices to which the endpoints concerned are assigned, which would otherwise be necessary.

There is one particularly nice advantageous effect in the case of an object for which the data is saved together with further data for charging for the data transmission. With this, each individual charge can, without expensive retrospective linking to separately managed data, include confirmation for the customer of the actual quality of service corresponding to the charge, in particular to reinforce the subscriber's confidence in the integrated voice-data networks, which are subject in principle to a fluctuating quality of service. Because of the direct linkage, this confirmation can be effected exceptionally effectively.

There is an advantage in the case of an object for which the data characterizes the quality of service in both transmission directions for a bidirectional data transmission, in that this eliminates the need for any retrospective correlation of the unidirectional measurements on the two transmission directions to give a bidirectional measurement.

In the case of an object with which the QoS data is transmitted to the instance after transmission of the user data, the resources for the transmission of the user data and the resources for the transmission of the QoS data are decoupled in time, with the advantage that the endpoint is not loaded with an additional transmission, especially during the user data transmission, which is generally comparatively resource-intensive.

An object by which the data is transmitted from the endpoint to the instance, e.g. as project-specific elements, in existing standardized signalling messages, in particular messages for indicating the completion of the user data transmission, is associated with the advantageous effect that the solution conforms to the standards, and no additional proprietary protocols or messages are required. Furthermore, the additional data which is inserted will have no effects on the network elements (transparency), which take no part in this technique: as before, they react only to the original part of the messages (interoperability with legacy network elements).

In the case of an alternative object, with which the data is transmitted from the endpoint to the instance in at least one additional and separate message, there is an advantageous effect in that the existing, standardized messages are totally unmodified, which is very important particularly in the case when these messages include no provision for additional protocols, which may be proprietary.

In what follows, the invention is explained in more detail by reference to exemplary embodiments, which are shown in the Figures. These show:

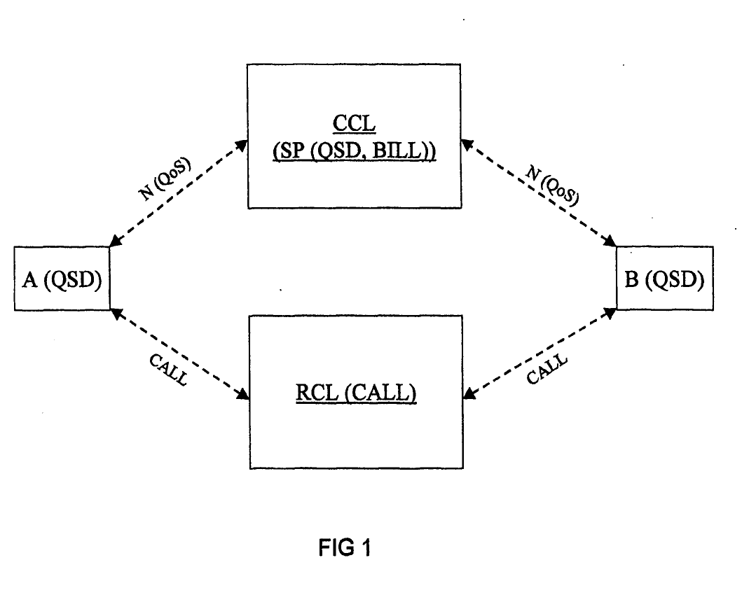

FIG. 1 An arrangement for carrying out the method in accordance with the invention, using a Call Control Level, a Resource Control Level, and two endpoints for a data transmission

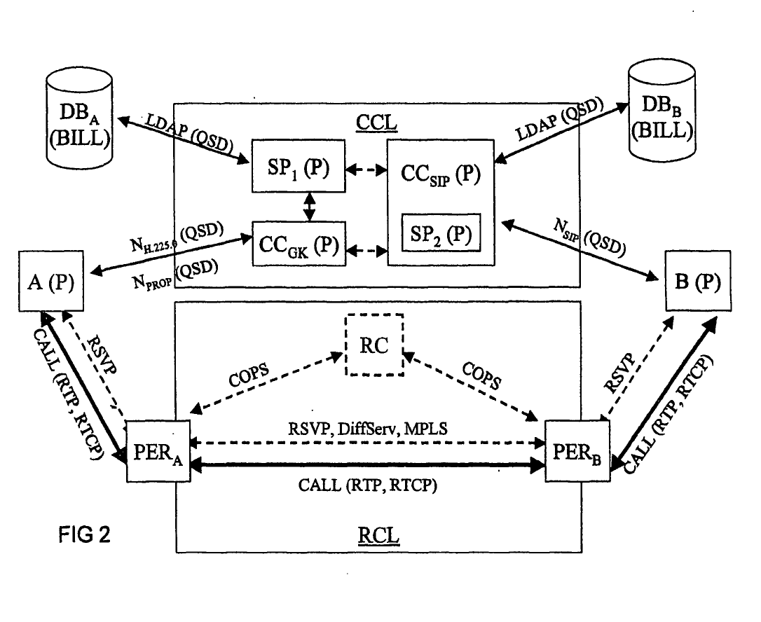

FIG. 2 an example showing a more detailed embodiment of the arrangement in accordance with FIG. 1, with computer program products for carrying out the method in accordance with the invention

FIG. 1 shows an example of an arrangement for performing the method in accordance with the invention, which takes the form of a communication network with a Call Control Level CCL, a Resource Control Level RCL, and two endpoints A, B for a user data transmission. A separate instance, SP, for storing the data QSD, BILL is located in the CCL level. Between the endpoints A, B, is shown a user data transmission CALL, which is communicated by the RCL level, and for which the data QSD is recorded in the terminal devices A, B to characterize the quality of service for the data communication CALL. Also shown are messages N between the terminal devices A, B and the CCL level, which are used to communicate the data QSD which has been collected at the instance SP.

FIG. 2 shows a more detailed embodiment of the arrangement in accordance with FIG. 1. It should be emphasized that the embodiments shown here are, in spite of being a very concrete representation in some respects, merely exemplary in nature, and should not be interpreted as being restrictive. In this embodiment, the CCL level includes two Call Controllers CC, with the Call Controller CC assigned to the endpoint A taking the form of a gatekeeper CC_{GK}, and the Call Controller CC assigned to the endpoint B taking the form of an SIP proxy, CC_{SIP}. Also shown are two embodiments SP₁, SP₂ of the separate instance SP. The first of these takes the form of an externally implemented separate instance SP₁, which is assigned to the gatekeeper CC_{GK}. It could also be assigned to the SIP proxy CC_{SIP} and act as the sole instance SP in the CCL level. This potential relationship is indicated by a dashed arrow between the instance SP₁ and the SIP proxy CC_{SIP}. The second takes the form of a separate instance SP2 which is implemented in integrated form, being integrated into the SIP proxy CC_{SIP}. For storage of the data QSD, BILL, a database DB_{A} is assigned to the first instance SP₁ and a database DB_{B} to the second instance SP₂ with the assignment in the second case being made via the SIP proxy CC_{SIP}. Access to the databases DB are made, for example, using the LDAP protocol (Lightweight Directory Access Protocol). If necessary, signalling messages N are exchanged between the two Call Controllers CC.

The RCL level includes a central Resource Controller RC. Assigned to this are two edge routers PER_{A}, PER_{B}, for the transmission of data in a communication network. Between the Resource Controller RC and the edge routers PER, use is made of a COPS protocol (Common Open Policy Service). In addition, between the endpoint A and the gatekeeper CC_{GK}, an H.225.0 protocol is used, between the endpoint A and the edge device PER_{A}, and between the endpoint B and the edge device PER_{B} an RSVP protocol (Resource Reservation Protocol), and between the endpoint B and the SIP proxy CC_{SIP} an SIP protocol (Session Initiation Protocol). The QSD data is communicated in each case by inclusion in the standardized messages N_{H.225.0}, N_{SIP} of the H.225.0, SIP and RSVP protocols. Alternatively the QSD data could, as indicated, be communicated in additional messages N_{PROP}, which might not be standardized. One of the protocols, for example RSVP, DiffServ, MPLS or COPS, is used for resource reservation between the edge devices PER_{A} and PER_{B}. A call CALL is indicated between the endpoints A and B. The user data is communicated over the communication network by an RTP protocol (Real Time Protocol). Here, control variables which have been evaluated for the QSD data in accordance with the invention are also transmitted between the two endpoints A, B in accordance with an RTCP protocol (Real Time Control Protocol) which is used in parallel with the RTP protocol.

The communication network may, for example, take the form of an IP network. It will be clear to the relevant specialists that the invention can of course be used in other types of network, such as the Internet, an intranet, extranet, local network (Local Area Network—LAN), or a company-internal network (corporate network) taking the form, for example, of a virtual private network (VPN).

Computer program products P in accordance with the invention are provided in the terminal devices A and B, the Call Controllers CC and the edge devices PER, each of which includes sections of software code for the processor-supported execution of the method in accordance with the invention. Here, parts of the computer program products P may also be executed on special hardware (e.g. crypto-processors).

In what follows, the behavior and interaction of the Call Controllers CC, the endpoints A, B and the instance or instances SP in the context of a data communication CALL will be set out as an example. In the exposition below, the data communication CALL will also be referred to as a call CALL.

First, the terminal device A is registered with the gatekeeper CC_{GK}. This registration is applied for by the terminal device A by means of an H.225.0 Registration Request RRQ, and the gatekeeper CC_{GK} replies with an H.225.0 Registration Confirm RCF or with an H.225.0 Registration Reject RRJ. The gatekeeper CC_{GK} then verifies the endpoint A, i.e. authenticates it, authorizes it, etc. . . . For this purpose user-specific data, for example stored in a database DB_{A}, is accessed using the LDAP protocol or another DB query protocol. The gatekeeper CC_{GK} also determines whether the call signalling is to be communicated by itself (gatekeeper routed call signalling) or directly between the endpoints A, B (direct endpoint call signalling), if necessary with reporting to the gatekeeper CC_{GK} of any significant changes. The terminal device B is registered with the SIP proxy CC_{SIP} in a similar way.

After the registration of both endpoints A, B, call signalling between the two terminal devices A, B is basically possible, and in particular call setup. This may be initiated, for example, by endpoint A making an application to the gatekeeper CC_{GK} by means of an H.225.0 Admission Request ARQ for the establishment of a call CALL to endpoint B. This ARQ could also contain a QoS request. At this point, the gatekeeper CC_{GK} carries out an authentication and authorization in relation to the call CALL. This includes an analysis of the QoS request. This can be determined, for example, by a Capability Negotiation between the two endpoints A, B, effected by means of further H.225.0 messages. In the case of Gatekeeper Routed Call Signalling, this will then be known immediately by the gatekeeper CC_{GK}. In the case of Direct Endpoint Call Signalling, the gatekeeper CC_{GK} could be informed of it. Optionally, the gatekeeper CC_{GK} may start charge metering for the call CALL, whereby further items of data, BILL, are generated. If the terminal device B takes the call CALL, this will be indicated to the gatekeeper CC_{GK} by a CONNECT message.

Following this, the endpoint A communicates an RSVP QoS request to the edge device PER_{A}. If an agreement has not already previously been negotiated between the gatekeeper CC_{GK} and Resource Controller RC, a further verification of the QoS request will now be carried out by the edge device. For this purpose a query is sent to the Resource Controller RC, for example using the COPS standardized protocol. This checks whether the required QoS can be provided in the communication network. For this purpose, the Resource Controller RC knows all the available (or busy) resources in the communication network, so that it can send a reply to the COPS query.

After receiving the reply from the Resource Controller RC, the edge device PER_{A} reacts are follows: either the QoS request will be rejected because of an overload in the communication network, or the configuration for the requested QoS will be set in the communication network, e.g. by dynamic activation of a policy or, as an alternative to RSVP scheduling in the edge device PER_{A}, by the forwarding of the RSVP reservation through the network as far as the other edge device PER_{B} or the endpoint B.

After receiving a positive RSVP reply from the edge device PER_{A}, the endpoint A starts the data transmission. At this point at the latest, charge metering is activated. In doing this the media data will be transmitted, e.g. in accordance with the RTP protocol. During the call CALL, additional data for controlling the flow of the call CALL is also transmitted in accordance with the RTCP protocol, and the QSD data is also recorded in the terminal devices A, B, taking into account the signalling data of the RTCP protocol which actually serves to control the flow. Because of the bidirectional nature of a call CALL, the QSD data recorded in the endpoint A, B can characterize the quality of service for both transmission directions, and indeed even if the two transmissions are made along different paths at the RCL level, because these two transmissions are recombined in one endpoint, so that QSD data to characterize the QoS can be recorded for both transmission directions. The subsequent combination of separately recorded QSD data is unnecessary.

The QSD data is stored temporarily in the terminal devices A, B, or is transmitted essentially immediately to the separate SP instance. The latter could, for example, take place at regular intervals of a few seconds. There are particularly nice advantages here if existing messages are used for the transmission of the QSD data. For example, during a call CALL the endpoint A and the gatekeeper CC_{GK} can, by a regular exchange of Keep Alive messages, keep in constant contact (in this connection, see H.225.0 (02/98), sections 7.9.1 and 7.9.2, the timeToLive parameter in a Registration Confirm message, RCF, for setting the life of the registration, and the keepAlive parameter in a Registration Request message RRQ, for refreshing, i.e. extending, the life of an existing registration). Usually, these Keep Alive messages are at regular intervals, of the order of seconds. The QSD data can be included in these messages.

The termination of the call CALL is indicated by terminal device A or B. In consequence, the gatekeeper CC_{GK} terminates the charge metering which may optionally have been started for the call CALL. After a short time, the reservation for the call CALL lapses in the communication network. The Resource Controller RC can then reassign the resources which have been released. By means of signals, the termination of the call CALL is also notified to the Call Controller CC_{SIP} at the other end.

If the QSD data items are stored temporarily, they are then transmitted in accordance with an embodiment of the invention to the instance SP, after CALL data communication. There are particularly nice advantages if this transmission in accordance with invention is effected using messages which already exist, in this exemplary embodiment the N_{H.225.0} or N_{SIP} messages, constructed respectively in accordance with the H.323 Standard family or the SIP protocol, by insertion of the QSD data items, e.g. as project-specific elements, into message fields which already exist, or if necessary are special, provided for in the relevant standards as free fields with no assigned functions (optional parameters). Naturally, it is also possible to use separate messages N_{PROP} for transmitting the data relevant to the invention.

The instance SP stores the QSD data in the database DB. In accordance with one embodiment of the invention, the QSD data items are stored together with the optionally compiled BILL data for charging for the call CALL. In this way, an especially efficient confirmation is possible of the quality of a call CALL which has been charged for, because the fact that the data items are stored together means that no subsequent assignment needs to be made by postprocessing.

On completion of the call CALL, the terminal devices A, B are ready for the establishment of further calls CALL. Preferably, the terminal devices A, B will be so constructed that the recording and storage of the QSD data in accordance with the invention is carried out for each call CALL.

In conclusion it should be emphasized that the description of the components in the communication network which are relevant for the invention should not be interpreted restrictively. In particular, to any specialist concerned it is clear that such terms as ‘endpoint’, ‘instance’ ‘Call Control Level’ or ‘Resource Control Level’ must be interpreted functionally and not physically. Consequently the endpoints A, B or the instance SP, for example, could also be implemented partly or completely in software and/or distributed across several physical devices.

1. A method for saving data (QoS) for characterizing the quality of service for a data transmission performed in at least one communication network comprising:
recording the data at least for each data transmission for which a specific quality of service has been promised beforehand by at least one endpoint of the data transmission;
transmitting the data thus recorded to at least one separate instance; and
storing the data by the separate instance.

2. A method in accordance with claim 1, wherein the instance is arranged in the Call Control Level of a communication network which includes a Call Control Level and a Resource Control Level.

3. A method in accordance with claim 2, wherein the instance is assigned to a Call Controller provided in the Call Control Level.

4. A method in accordance with claim 1, wherein the data is saved together with additional data for charging for the data communication.

5. A method in accordance with claim 1, wherein the data in the case of a bidirectional data transmission characterizes the quality of service for both transmission directions.

6. A method in accordance with claim 1, wherein the data is transmitted to the instance after the data transmission.

7. A method in accordance with claim 1, wherein the data is transmitted by the endpoint to the instance in available, standardized signalling messages.

8. A method in accordance with claim 7, wherein the data is inserted as project-specific elements into the available standardized signalling messages.

9. A method in accordance with claim 1, wherein the data is transmitted by the endpoint to the instance in at least one additional, separate message.

10. A computer program product for performing a method for saving data for characterizing the quality of service for a data transmission in at least one communication network, the method comprising:
recording the data at least for each data transmission for which a specific quality of service has been promised beforehand by at least one endpoint of the data transmission;
transmitting the data thus recorded to at least one separate instance; and
storing the data by the separate instance.

11. A separate entity for performing a method for saving data for characterizing the quality of service for a data transmission in at least one communication network, the method comprising:
recording the data at least for each data transmission for which a specific quality of service has been promised beforehand by at least one endpoint of the data transmission;
transmitting the data thus recorded to at least one separate instance; and
storing the data by the separate instance.

12. An endpoint including facilities for performing a method for saving data for characterizing the quality of service for a data transmission in at least one communication network, the method comprising:
recording the data at least for each data transmission for which a specific quality of service has been promised beforehand by at least one endpoint of the data transmission;
transmitting the data thus recorded to at least one separate entity; and
storing the data by the separate entity.

13. An endpoint in accordance with claim 12, wherein the facilities are so constructed that the method is performed for each data transmission.

14. An endpoint in accordance with claim 13, whereby wherein the facilities are so constructed that the data for characterizing the quality of service for a data transmission is continuously recorded for each data transmission.

15. A method in accordance with claim 2, wherein the data is saved together with additional data for charging for the data communication.

16. A method in accordance with claim 2, wherein the data in the case of a bidirectional data transmission characterizes the quality of service for both transmission directions.

17. A method in accordance with claim 7, wherein the standardized signalling messages are N_{H.225.0} and/or N_{SIP}.

18. A method in accordance with claim 7, wherein the standardized signalling messages are used to indicate the termination of a data transmission.
